(19) United States
(12) Patent Application Publication
(10) Pub. No.: US 2021/0271285 A1
(43) Pub. Date: Sep. 2, 2021

(54) PEDAL ASSEMBLY FOR A MOTOR VEHICLE

(71) Applicant: HELLA GmbH & Co. KGaA, Lippstadt (DE)

(72) Inventor: Claus VIETHEN, Erwitte (DE)

(73) Assignee: HELLA GmbH & Co. KGaA, Lippstadt (DE)

(21) Appl. No.: 17/322,292

(22) Filed: May 17, 2021

Related U.S. Application Data
(63) Continuation of application No. PCT/EP2018/081382, filed on Nov. 15, 2018.

(51) Int. Cl. G05G 1/36; B60T 7/06; B60K 26/02

(52) U.S. Cl. CPC G05G 1/36; B60K 26/02; B60T 7/06

(57) ABSTRACT

A pedal assembly for a motor vehicle with at least one support and at least two pedals, each comprising a pedal arm mounted to the at least one support and pivotable around a corresponding pivot axis, a sensor for detecting a rotational movement of the pedal arm around the pivot axis and an interface for an electrical contact of the sensor with a control unit of the motor vehicle. In order to provide a pedal assembly for a motor vehicle, which shows an easy design, the at least one support is designed as a single base plate for the at least two pedals and at least one of the at least two pedals is housed by the single base plate, whereat the pedal arm of the housed pedal is extending through a pedal arm opening of the single base plate.

This nonprovisional application is a continuation of International Application No. PCT/EP2018/081382, which was filed on Nov. 15, 2018 and which is herein incorporated by reference.

### BACKGROUND OF THE INVENTION

### Field of the Invention

The present invention relates to a pedal assembly for a motor vehicle.

### Description of the Background Art

Pedal assemblies for motor vehicles, with at least one support and at least two pedals, each comprising a pedal arm mounted to the at least one support and pivotable around a corresponding pivot axis, a sensor for detecting a rotational movement of the pedal arm around the pivot axis and an interface for an electrical contact of the sensor with a control unit of the motor vehicle, are known in different embodiments.

Furthermore, from the DE 10 2007 059 376 A1 a pedal assembly for a motor vehicle is known, too. This pedal assembly is designed as a modular pedal assembly with two frame-like supports and two pedals, each comprising a pedal arm mounted to the corresponding support and pivotable around a corresponding pivot axis.

### SUMMARY OF THE INVENTION

It is therefore an object of the present invention to provide a pedal assembly for a motor vehicle, which shows an easy design.

This object of the invention is solved by a pedal assembly for a motor vehicle, wherein the at least one support is designed as a single base plate for the at least two pedals and at least one of the at least two pedals is housed by the single base plate, whereat the pedal arm of the housed pedal is extending through a pedal arm opening of the single base plate.

An advantage of the pedal assembly for a motor vehicle according to the invention is, that the inventive pedal assembly shows an easy design, thus can be realized with less effort. Furthermore, the inventive pedal assembly can be manufactured with less material and less assembly work. Therefore, the inventive pedal assembly for a motor vehicle can be cost saving. This can be achieved by the inventive pedal assembly for a motor vehicle.

Basically, the design of the pedal assembly for a motor vehicle according to the invention can be of any suitable shape, material, dimension and number of pedals as well as number of pedals housed by the single base plate. Advantageously, at least two of the at least two pedals are housed by the single base plate. That way, the design of the pedal assembly for a motor vehicle according to the invention is further simplified.

A preferable development of the pedal assembly for a motor vehicle according to the invention is, that the single base plate is designed, that the at least one pedal housed by the single base plate is mountable from a rear side of the single base plate, whereat the rear side is facing a frame of the motor vehicle the pedal assembly is mounted to. Hereby, the design of the inventive pedal assembly for a motor vehicle according to the invention is furthermore simplified. A separate cover for housing this pedal is not necessary. Moreover, a major problem of pedal assemblies for motor vehicles is, that there is always a risk of getting debris like small stones into the mechanism of the pedal assembly. The pedal assembly according to the aforementioned embodiment of the invention solves or reduces this problem by employing an easy design, too. This is especially true for pedal assemblies designed for so called standing pedals for motor vehicles.

A preferable development of the aforementioned embodiment of the inventive pedal assembly for a motor vehicle is, that the single base plate is comprising a frame part for the at least one pedal housed by the single base plate. That way, the single base plate can be realized with less material and shows an easy design, too.

Another advantageous development of the pedal assembly according to the invention is, that the pedal arm of the at least one pedal housed by the single base plate comprises a central part corresponding to the single base plate and an actuation part linked to the central part in a power transmitting manner. Hereby, the assembly of the at least one pedal housed by the single base plate is simplified. Furthermore, the size of the pedal arm opening for the pedal arm of the at least one pedal housed by the single base plate can be reduced. Thus, the risk of getting debris like small stones into the mechanism of the pedal assembly can be reduced, too.

A further advantageous development of the pedal assembly for a motor vehicle according to the invention is, that the at least two pedals comprise at least one pedal not housed by the single base plate, whereat the at least one pedal not housed by the single base plate is housed by a separate cover mounted to the single base plate. That way, the assembly of the at least one pedal not housed by the single base plate can be done from a front side of the single base plate positioned opposite to a rear side of the single base plate facing a frame of the motor vehicle the inventive pedal assembly is mounted to. Moreover, the pedal housed by the separate cover mounted to the single base plate can be accessed quite easily without the need for dismounting the inventive pedal assembly form the frame of the motor vehicle.

Another advantageous development of the pedal assembly for a motor vehicle according to the invention is, that the sensor of the pedal housed by the single base plate is designed as a separate sensor module and incorporated through a sensor opening of the single base plate. Hereby, the sensor of the pedal housed by the single base plate can be assembled to the single base plate quite easily. Furthermore, the sensor can be preconfigured and/or sourced from a supplier more easily.

A particular preferable development of the aforementioned embodiment of the pedal assembly for a motor vehicle according to the invention is, that the interface corresponding to the sensor of the pedal housed by the single base plate is designed as an integral part of the separate sensor module. Thus, the interface and the sensor corresponding to the interface can be preconfigured and/or sourced from a supplier as a single part. No further workload for electrically and mechanically connecting the interface to the separate sensor module or to another type of sensor configuration has to be spent.

In general, the single base plate and/or the separate cover can be of any kind, shape, material, dimension and position to the rest of the inventive pedal assembly for a motor vehicle. Advantageously, the single base plate and/or the separate cover are/is built from plastics. Plastics are available in a broad variety with different characteristics. Furthermore, plastics are lightweight material and easy to process.

Another advantageous development of the pedal assembly for a motor vehicle according to the invention is, that the at least two pedals of the pedal assembly are designed as an accelerator pedal and a brake pedal. Every motor vehicle, with an automatic gearbox or with a manual gearbox, does have at least an accelerator pedal and a brake pedal. Thus, the pedal assembly for a motor vehicle according to this embodiment can be produced in a high number of units. Despite this, the pedal assembly for a motor vehicle according to the invention may comprise other kinds of pedals, too. For example, the inventive pedal assembly may comprise three pedals, namely a clutch pedal, a brake pedal and an accelerator pedal. Other embodiments may comprise only a clutch pedal and a brake pedal.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an embodiment of the pedal assembly for a motor vehicle according to the invention in a perspective view facing a front side of the pedal assembly;

FIG. 2 is the embodiment of FIG. 1 in an exploded view; and

FIG. 3 is the embodiment of FIG. 1 in a perspective view facing a rear side of the pedal assembly.

### DETAILED DESCRIPTION

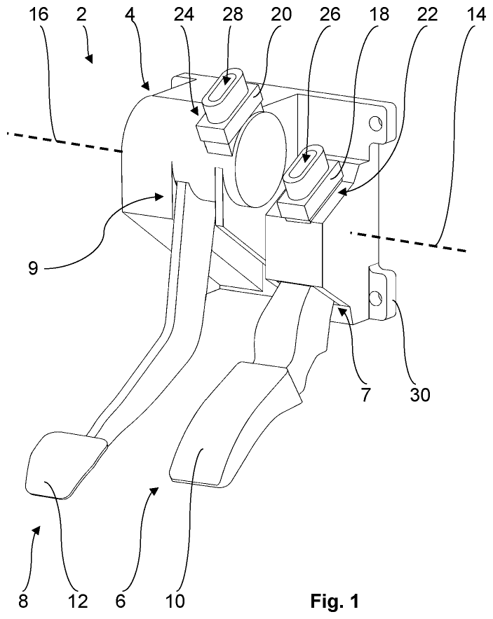

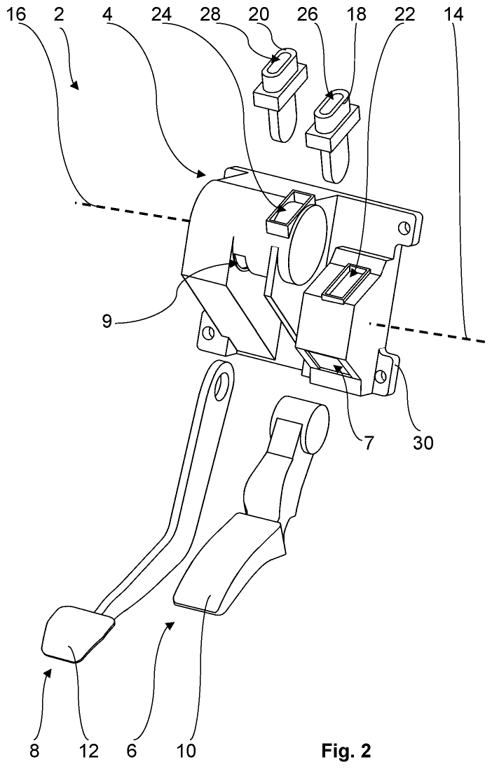

FIG. 1 displays an embodiment of a pedal assembly 2 for a motor vehicle in a first perspective view with a single support 4 and two pedals, namely an accelerator pedal 6 and a brake pedal 8. The first perspective view is showing the single support 4 from a front side of the single support 4, which is facing a user of the pedal assembly 2 and arranged opposite to a rear side of the single support 4. The single support 4 is designed as a single base plate for the two pedals 6, 8 and made from plastics. The accelerator pedal 6 comprises a pedal arm 10 and the brake pedal 8 comprises a pedal arm 12. Each pedal arm 10, 12 is mounted to the single support 4 and pivotable around a corresponding pivot axis, namely a pivot axis of the pedal arm 10 of the accelerator pedal 6 and a pivot axis of the pedal arm 12 of the brake pedal 8. Both of the two pedals 6, 8 are housed by the single base plate 4, whereat the pedal arm 10 of the accelerator pedal 6 is extending through a pedal arm opening 7 of the single base plate 4 and the pedal arm 12 of the brake pedal 8 is extending through a pedal arm opening 9 of the single base plate 4. The pedal arms 10, 12 as well as the corresponding pedal arm openings 7, 9 are shown in an exploded view in FIG. 2. The motor vehicle is not displayed.

The pivot axis of the pedal arm 10 of the accelerator pedal 6 is symbolized by a broken line 14 and the pivot axis of the pedal arm 12 of the brake pedal 8 is symbolized by a broken line 16. Furthermore, the pedal assembly 2 comprises a sensor 18 for detecting a rotational movement of the pedal arm 10 of the accelerator pedal 6 around the pivot axis 14 and a sensor 20 for detecting a rotational movement of the pedal arm 12 of the brake pedal 8 around the pivot axis 16. Each of the sensors 18, 20 of the accelerator pedal 6 and the brake pedal 8 is designed as a separate sensor module and incorporated through a sensor opening 22, 24 of the single base plate 4. The separate sensor module 18 of the accelerator pedal 6 and the sensor module 20 of the brake pedal 8 as well as the corresponding sensor openings 22, 24 of the single base plate 4 are shown in an exploded view in FIG. 2.

An interface 26 for an electrical contact of the sensor 18 with a control unit of the motor vehicle and an interface 28 for an electrical contact of the sensor 20 with the control unit of the motor vehicle each is incorporated in the corresponding separate sensor module 18, 20, namely the interface 26 is incorporated in the separate sensor module 18 corresponding to the accelerator pedal 6 and the interface 28 is incorporated in the separate sensor module 20 corresponding to the brake pedal 8. Thus, the interface 26 is designed as an integral part of the separate sensor module 18 and the interface 28 is designed as an integral part of the separate sensor module 20. The control unit is not displayed.

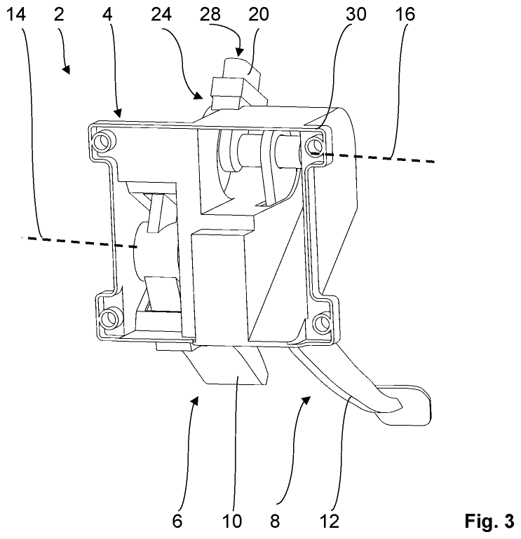

FIG. 3 displays the pedal assembly 2 in a second perspective view showing the pedal assembly 2 from a rear side of the base plate 4, which is facing a frame of the motor vehicle the pedal assembly 2 is mounted to. The frame of the motor vehicle is not displayed. As can be seen best from FIG. 3, the single base plate 4 is comprising a frame part 30 for the accelerator pedal 6 and the brake pedal 8, each housed by the single base plate 4.

In the following, the function of the embodiment of a pedal assembly for a motor vehicle according to the invention is explained by means of FIGS. 1 to 3.

In order to manufacture the pedal assembly 2 the accelerator pedal 6 and the brake pedal 8 each are assembled from the rear side of the single base plate 4 via the frame part 30 of the single base plate 4; see FIG. 3. The pedal arms 10, 12 of the accelerator pedal 6 and the brake pedal 8 each are fed through the corresponding pedal arm openings 7, 9 of the single base plate 4 from the rear side of the single base plate 4. Thus, after the assembly of the accelerator pedal 6 and the brake pedal 8 the pedal arm 10 of the accelerator pedal 6 is extending through the pedal arm opening 7 and the pedal arm 12 of the brake pedal 8 is extending through the pedal arm opening 9. See FIG. 1.

The separate sensor module 18 of the accelerator pedal 6 is inserted into the sensor opening 22 of the single base plate 4 and the separate sensor module 20 of the brake pedal 8 is inserted into the sensor opening 24 of the single base plate 4. See FIG. 2.

A user of the pedal assembly 2, namely a driver of the motor vehicle, is pressing the pedal arm 10 of the accelerator pedal 6 in order to accelerate the motor vehicle. The pedal arm 10 is pivoted around the pivot axis 14 of the pedal arm 10. This pivot action of the pedal arm 10 around the pivot axis 14 is detected by the separate sensor module 18 corresponding to the accelerator pedal 6. The aforementioned pivot action of the accelerator pedal 6 is transferred to the control unit of the motor vehicle via the interface 26 of the separate sensor module 18. In case the user is no longer pressing the pedal arm 10 of the accelerator pedal 6, the pedal arm 10 is pivoted in opposite direction around the pivot axis 14 of the pedal arm 10. This pivot action of the accelerator pedal 6 is transferred to the control unit of the motor vehicle, too.

The function of the brake pedal 8 is analog to the function of the accelerator pedal 6 explained above. Thus, the user of the pedal assembly 2 is pressing the pedal arm 12 of the brake pedal 8 in order to decelerate the motor vehicle. The pedal arm 12 is pivoted around the pivot axis 16 of the pedal arm 12. This pivot action of the pedal arm 12 around the pivot axis 16 is detected by the separate sensor module 20 corresponding to the brake pedal 8. The aforementioned pivot action of the brake pedal 8 is transferred to the control unit of the motor vehicle via the interface 28 of the separate sensor module 20. In case the user is no longer pressing the pedal arm 12 of the brake pedal 8, the pedal arm 12 is pivoted in opposite direction around the pivot axis 16 of the pedal arm 12. This pivot action of the brake pedal 8 is also transferred to the control unit of the motor vehicle.

The invention is not limited to the exemplary embodiment of the pedal assembly for a motor vehicle according to the invention discussed before.

Of course, the invention is not limited to an inventive pedal assembly comprising an accelerator pedal and a brake pedal. For example, another embodiment of the invention may comprise an acceleration pedal, a brake pedal and a clutch pedal. Still another embodiment of the invention may comprise a brake pedal and a clutch pedal.

In contrast to the embodiment of the invention explained, the pedal arm of the at least one pedal housed by the single base plate may comprise a central part corresponding to the single base plate and an actuation part linked to the central part in a power transmitting manner. Hereby, the assembly of the at least one pedal housed by the single base plate is simplified. Furthermore, the size of the pedal arm opening for the pedal arm of the at least one pedal housed by the single base plate can be reduced. Thus, the risk of getting debris like small stones into the mechanism of the pedal assembly can be reduced, too.

Furthermore, it is possible, that the at least two pedals comprise at least one pedal not housed by the single base plate, whereat the at least one pedal not housed by the single base plate is housed by a separate cover mounted to the single base plate. That way, the assembly of the at least one pedal not housed by the single base plate can be done from a front side of the single base plate positioned opposite to a rear side of the single base plate facing a frame of the motor vehicle the inventive pedal assembly is mounted to. Moreover, the pedal housed by the separate cover mounted to the single base plate can be accessed quite easily without the need for dismounting the inventive pedal assembly form the frame of the motor vehicle. A preferred embodiment of the aforementioned embodiment could be, that the separate cover is built from plastics. Plastics are available in a broad variety with different characteristics. Furthermore, plastics are lightweight materials and easy to process.

A main advantage of the pedal assembly for a motor vehicle according to the invention is, that the inventive pedal assembly shows an easy design, thus can be realized with less effort. Furthermore, the inventive pedal assembly can be manufactured with less material and less assembly work. Therefore, the inventive pedal assembly for a motor vehicle can be cost saving. This can be achieved by the inventive pedal assembly for a motor vehicle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A pedal assembly for a motor vehicle comprising:
at least one support; and
at least two pedals, each of the at least two pedals comprising a pedal arm mounted to the at least one support and pivotable around a corresponding pivot axis, a sensor for detecting a rotational movement of the pedal arm around the pivot axis and an interface for an electrical contact of the sensor with a control unit of the motor vehicle,
wherein the at least one support is designed as a single base plate for the at least two pedals and at least one of the at least two pedals is housed by the single base plate, and
wherein the pedal arm of the housed pedal is extending through a pedal arm opening of the single base plate.

2. The pedal assembly according to claim 1, wherein at least two of the at least two pedals are housed by the single base plate.

3. The pedal assembly according to claim 1, wherein the single base plate is designed such that the at least one pedal housed by the single base plate is mountable from a rear side of the single base plate, and wherein the rear side is facing a frame of the motor vehicle that the pedal assembly is mounted to.

4. The pedal assembly according to claim 3, wherein the single base plate comprises a frame part for the at least one pedal housed by the single base plate.

5. Pedal assembly according to claim 1, wherein the pedal arm of at least one pedal housed by the single base plate comprises a central part corresponding to the single base plate and an actuation part linked to the central part in a power transmitting manner.

6. The pedal assembly according to claim 1, wherein the at least two pedals comprise at least one pedal not housed by the single base plate, whereat the at least one pedal not housed by the single base plate is housed by a separate cover mounted to the single base plate

7. The pedal assembly according to claim 1, wherein the sensor of the pedal housed by the single base plate is designed as a separate sensor module and incorporated through a sensor opening of the single base plate.

8. The pedal assembly according to claim 7, wherein the interface corresponding to the sensor of the pedal housed by the single base plate is designed as an integral part of the separate sensor module.

9. The pedal assembly according to claim 1, wherein the single base plate and/or the separate cover are/is built from plastics.

10. The pedal assembly according to claim 1, wherein the at least two pedals of the pedal assembly are designed as an accelerator pedal and a brake pedal.
